(19) United States
(12) Patent Application Publication
(10) Pub. No.: US 2024/0270001 A1
(43) Pub. Date: Aug. 15, 2024

(54) PRECISION MOTION

(71) Applicant: Zuta Labs Ltd., Jerusalem (IL)

(72) Inventors: Yitzchak KEMPINSKI, Geva Binyamin (IL); Sraya GOLDFISHER, Shim’a (IL); Aryeh GROSS, Sde Ya’akov (IL)

(21) Appl. No.: 18/440,284

(22) Filed: Feb. 13, 2024

Related U.S. Application Data
(60) Provisional application No. 63/445,373, filed on Feb. 14, 2023.

(51) Int. Cl. B41J 25/00; B41J 29/13; B62D 57/028

(52) U.S. Cl. CPC B41J 25/001; B41J 29/13; B62D 57/028

(57) ABSTRACT

An apparatus includes a robot has an effector head and a motorized wheel coupled to the effector head. The wheel is configured to roll the effector head along a roll axis of a surface. The robot also has a foot, coupled to the effector head, that is operable to walk the effector head along a step axis that is orthogonal to the roll axis. To walk the effector head, the foot engages the surface, lifts the wheel from the surface and while the wheel remains lifted from the surface, advances the effector head along the step axis. The wheel is then returned to the surface, and the foot disengages from the surface. Other embodiments are also described.

### CROSS-REFERENCES TO RELATED APPLICATIONS

The present application claims the benefit of Provisional US Patent Application U.S. 63/445,373 to Kempinski et al., filed Feb. 14, 2023, and titled “Precision Motion,” which is incorporated herein by reference in its entirety.

### FIELD OF THE INVENTION

Some applications of the present invention relate in general to precision motion. More specifically, some applications of the present invention relate to precision motion of a robot along a pair of orthogonally opposed axes.

### SUMMARY OF THE INVENTION

This summary is meant to provide some examples and is not intended to be limiting of the scope of the invention in any way. For example, any feature included in an example of this summary is not required by the claims, unless the claims explicitly recite the features. Also, the features, components, steps, concepts, etc. described in examples in this summary and elsewhere in this disclosure can be combined in a variety of ways. Various features and steps as described elsewhere in this disclosure may be included in the examples summarized here.

Applications of the present invention are directed to apparatus and methods for robotically moving an effector head relative to a surface, along a pair of orthogonally opposed axes. For some implementations, a robot has a roll state in which the robot's wheel rolls the robot along a roll axis. Typically for such implementations, the robot comprises a foot that propels the robot along a step axis that is orthogonal to the roll axis (e.g., causing the robot to take a step having a predetermined step length).

For some such implementations, while rolling along the roll axis holds, the robot holds the effector head at an effector height from the surface, and while the robot takes a step, the foot elevates the effector head to a step-height from the surface that is greater than the effector height.

For some implementations, the robot is a robotic printer, and the effector head is a print head that is moved along the pair of axes to print on a surface. For some such implementations, while the printer is in the roll state, the printer holds the print head at a print height from the surface, to print a row of material on the surface. Typically for such implementations, the printer then takes a step in order to position the printer for printing the next row of material on the surface.

Typically, the foot: (i) is held away from the surface while the printer is in the roll state, so as not to interfere with smooth rolling of the printer, and (ii) lifts the wheel from the surface when the printer takes the step, so that the wheel does not interfere with the printer's movement along the step axis.

There is therefore provided, in accordance with an application of the present invention, an apparatus, the apparatus comprising a robot that comprises:
an effector head;
a motorized wheel, coupled to the effector head, and configured to roll the effector head along a roll axis of a surface; and
a foot, the foot coupled to the effector head, and operable to walk the effector head along a step axis by, in order:
   engaging the surface,
   lifting the wheel from the surface,
   while the wheel remains lifted from the surface, advancing the effector head along the step axis with respect to the surface, the step axis being orthogonal to the roll axis,
   returning the wheel to the surface, and
   disengaging from the surface.

In an application, the foot is a first foot of a plurality of motorized feet, each of the feet being coupled to the effector head.

In an application, the robot is configured to roll the effector head along the roll axis while the effector head is held at an effector height from the surface.

In an application, the robot is configured such that operation of the foot elevates the effector head to a step-height from the surface, the step-height being greater than the effector height.

In an application, the foot is operable to walk the effector head along the step axis by revolving the foot with respect to the effector head.

In an application, the apparatus further comprises a crank, the crank:
coupling the foot to the effector head, and
configured to operate the foot by revolving the foot with respect to the effector head.

In an application, the apparatus further comprises a housing that houses the effector head, wherein:
the housing has a base face,
the wheel is configured to roll the effector head along the roll axis while the base face faces the surface, and
the foot is operable to walk the effector head along the step axis by:
   protruding from the base face,
   while continuing to protrude from the base face, propelling the housing along the step axis, and
   subsequently, retracting into the housing.

In an application, the wheel is configured to roll the effector head along the roll axis while the foot does not protrude from the base face.

In an application, the wheel is a first wheel of a set of motorized wheels, each wheel of the set being coupled to the effector head.

In an application, the set of wheels is a set of four wheels.

In an application, each wheel of the set is positioned laterally from the effector head.

In an application, the wheel is a drive wheel, and wherein the robot further comprises a tracking wheel, configured to track a distance travelled by the robot along the roll axis.

In an application, the tracking wheel is configured to track the distance independently of the drive wheel, via contact between the tracking wheel and the surface.

There is further provided, in accordance with an application of the present invention, an apparatus for printing on a surface, the apparatus comprising a printer that comprises:
a print head, configured to print on the surface;
a housing, housing the print head;
a motorized wheel, coupled to the housing; and
a motorized foot, coupled to the housing,
   wherein the printer is configured to rest on the surface such that:
in a roll state of the printer:
   the wheel is in contact with the surface, such that turning of the wheel rolls the printer along the surface on a roll axis,
   the print head is held at a constant print height from the surface, and
   the foot is held away from the surface; and
operation of the foot causes the printer to take a step along the surface on a step axis that is orthogonal to the roll axis, the step transiently removing the printer from the roll state by lifting the wheel away from the surface.

In an application, the print head is a laser print head.

In an application, the print head is an inkjet print head.

In an application, the print head is a thermal print head.

In an application, the print head is an etcher.

In an application:
the surface is a paper surface,
the print head is configured to print on the paper surface, and
the motorized wheel is configured to roll the printer along the paper surface.

In an application, the print head is fixedly mounted to the housing.

In an application, the foot is a first foot of a plurality of motorized feet, each of the feet being coupled to the housing.

In an application, the printer is configured such that operation of the foot elevates the print head to a step-height from the surface, the step-height being greater than the print height.

In an application, the apparatus is configured such that operation of the foot causes the printer to take the step along the surface on the step axis by revolving the foot with respect to the housing such that the foot:
transiently lifts the wheel away from the surface, and
advances the housing along the step axis.

In an application, the apparatus is configured such that operation of the foot causes the printer to take the step along the surface on the step axis by revolving the foot with respect to the housing such that the foot advances the housing along the step axis while the foot remains at a constant position on the surface.

In an application, the foot is coupled to the housing by a crank, the crank configured such that revolving the crank revolves the foot with respect to the housing, such that during a revolution of the crank, the foot:
transiently lifts the wheel away from the surface, and
advances the housing along the step axis.

In an application:
the housing has a base face,
in the roll state, the base face faces the surface, and
operation of the foot causes the foot to, during the step:
   protrude from the base face,
   while continuing to protrude from the base face, propel the housing along the step axis, and
   subsequently, retract into the housing.

In an application, while the printer is in the roll state, the foot does not protrude from the base face.

In an application, the wheel is a first wheel of a set of motorized wheels, each wheel of the set being coupled to the housing.

In an application, each wheel of the set is positioned laterally from the housing.

In an application, the set of wheels is a set comprising at least two wheels.

In an application, the set of wheels is a set comprising four wheels.

In an application, the wheel is a drive wheel, and wherein the printer further comprises a tracking wheel, configured to track a distance travelled by the printer along the roll axis.

In an application, the tracking wheel is configured to track the distance independently of the drive wheel, via contact between the tracking wheel and the surface.

There is further provided, in accordance with an application of the present invention, an apparatus for printing on a surface, the apparatus comprising a printer that comprises:
a print head, configured to print on the surface;
a motorized wheel, coupled to the print head, and configured to roll the print head along a roll axis of the surface while the print head is held at a print height from the surface; and
a foot, the foot coupled to the print head, and operable to walk the print head along a step axis by, in order:
   engaging the surface,
   lifting the wheel from the surface,
   while the wheel remains lifted from the surface, advancing the print head along the step axis with respect to the surface, the step axis being orthogonal to the roll axis,
   returning the wheel to the surface, and
   disengaging from the surface.

In an application, the print head is a laser print head.

In an application, the print head is an inkjet print head.

In an application, the print head is a thermal print head.

In an application, the print head is an etcher.

In an application:
the surface is a paper surface,
the print head is configured to print on the paper surface, and
the motorized wheel is configured to roll the printer along the paper surface.

In an application, the foot is a first foot of a plurality of motorized feet, each of the feet being coupled to the print head.

In an application, the printer is configured such that operation of the foot elevates the print head to a step-height from the surface, the step-height being greater than the print height.

In an application, the foot is operable to walk the print head along the step axis by revolving the foot with respect to the print head.

In an application, the apparatus further comprises a crank, the crank:
coupling the foot to the print head, and
configured to operate the foot by revolving the foot with respect to the print head.

In an application, the apparatus further comprises a housing that houses the print head, wherein:
the housing has a base face,
the wheel is configured to roll the print head along the roll axis while the base face faces the surface, and
the foot is operable to walk the print head along the step axis by:
   protruding from the base face,
   while continuing to protrude from the base face, propelling the housing along the step axis, and
   subsequently, retracting into the housing.

In an application, the wheel is configured to roll the print head along the roll axis while the foot does not protrude from the base face.

In an application, the wheel is a first wheel of a set of motorized wheels, each wheel of the set being coupled to the print head.

In an application, the set of wheels is a set of four wheels.

In an application, each wheel of the set is positioned laterally from the print head.

In an application, the wheel is a drive wheel, and wherein the printer further comprises a tracking wheel, configured to track a distance travelled by the printer along the roll axis.

In an application, the tracking wheel is configured to track the distance independently of the drive wheel, via contact between the tracking wheel and the surface.

The present invention will be more fully understood from the following detailed description of applications thereof, taken together with the drawings, in which:

### BRIEF DESCRIPTION OF THE DRAWINGS

FIGS. 1A-B, 2, 3A-B and 4 are schematic illustrations showing a robotic printer, in accordance with some applications of the invention; and

FIGS. 5-10 are schematic illustrations showing a robotic printer, in accordance with some applications of the invention.

### DETAILED DESCRIPTION OF EMBODIMENTS

The described systems, apparatuses, devices, methods, etc. should not be construed as limiting in any way. Instead, the present disclosure is directed toward all novel and nonobvious features and aspects of the various disclosed implementations and applications, alone and in various combinations and sub-combinations with one another. The disclosed systems, apparatuses, devices, methods, etc. are not limited to any specific aspect, feature, or combination thereof, nor do the disclosed systems, apparatuses, devices, methods, etc. require that any one or more specific advantages be present or problems be solved.

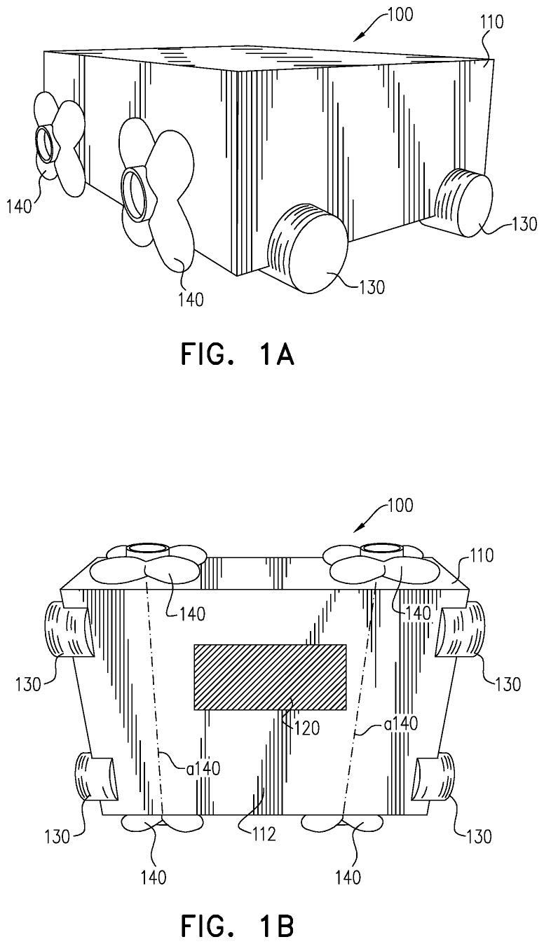

Reference is made to FIGS. 1A-B, 2, 3A-B and 4, which are schematic illustrations showing a printer 100, in accordance with some applications of the invention.

FIGS. 1A-1B are a perspective views of a robotic printer 100. For some implementations, and as shown, printer 100 comprises a housing 110 that houses a print head 120 that is configured to print on a surface (i.e., a substrate) 10. For example, print head 120 may comprise a laser print head, an inkjet print head, a thermal print head, or an etching print head.

It is to be noted that robotic printer 100 is an example of a robot that moves accurately along a pair of orthogonally opposed axes. This example is nonlimiting, and other implementations of the invention include robots that hold effector heads that, mutatis mutandis: paint lines or marks on a surface, cut, engrave, stitch or sew, drive nails or staples, measure a distance, scan a surface, plant seeds or seedlings, perform cleaning procedures, and/or place objects at predetermined locations along orthogonally opposed axes.

Printer 100 comprises a motorized wheel 130 (e.g., a set of motorized wheels, such as the set of four wheels positioned laterally from housing 110 shown) that roll the printer along a roll axis a120 (FIG. 2). Printer further comprises a motorized foot 140 (e.g., a plurality of motorized feet, as shown) that walks printer 100 orthogonally to the roll axis.

Wheels 130 and feet 140 are typically each coupled to print head 120. For some implementations, print head 120 is fixedly mounted to housing 110, such that wheels 130 and feet 140 are coupled to the print head via the housing.

FIG. 2 shows use of wheels 130 to roll printer 100 along surface 10 (e.g., a paper surface). For some implementations, while the printer is in a roll state, the printer rests on surface 10 with each wheel 130 in contact with the surface. In this way, turning wheels 130 (e.g., by activating a motor that operates the wheels) causes printer 100 to roll along roll axis a120. For some implementations, each foot 140 is held away from surface 10 while printer 100 is in the roll state, so as not to interfere with smooth rolling of the printer.

For such implementations, print head 120 is held at a constant print height p120 from surface 10 while printer 100 is in the roll state, facilitating use of the print head to print on the surface while printer 100 rolls across the surface. In this way, a line of print is printed as printer 100 rolls along roll axis a120.

FIGS. 3A-3B show printer 100 taking a step along a step axis a150 that is orthogonal to roll axis a120, e.g., in order to position print head 120 for printing the next line of print. The left-side frame of FIG. 3A shows printer 100 in its roll state at the end of the print line of FIG. 2. The left-side of FIG. 3A shows the printer again in its roll state, but on the next print line (i.e., its print head is on the next print line). Thus, the transition from the left-side frame to the right-side frame represents a single step of printer 100.

Whereas FIG. 3A is a top-down view of printer 100 on surface 10, and shows the printer before and after a step, FIG. 3B is a side view, and also shows the printer partway through that step. As shown, when printer 100 takes a step, feet 140 typically transiently lift wheels 130 away from surface 10. The upper frame of FIG. 3B is a side view of printer 100 in the same roll state and position as the left-frame of FIG. 3A. In this state, wheels 130 contact surface 10, and feet 140 typically do not contact the surface. The middle frame of FIG. 3B shows feet having engaged surface 10, to lift the wheels 130 from the surface and propel the printer (e.g., housing 110 thereof) one step forward. The bottom frame of FIG. 3B shows printer 100 in the same roll state and position as the right-frame of FIG. 3A—i.e., after the step is complete and the printer (i.e. its print head) is on the next print line. In the example shown, feet 140 are mounted on a foot axle a140 (shown in phantom in FIG. 1B), and are operated by rotating the foot axle about its axis (i.e., a foot axis).

It is to be noted that, in contrast to “rolling”, a “step” is a movement of discrete (and typically preconfigured) distance—e.g., as represented by step length s1 in FIGS. 3A and 3B.

For some implementations, and as shown in the middle frame of FIG. 3B, operation of feet 140 also elevates, from surface 10, print head 120 and/or a base face 112 of housing 110, to a step-height s120 that is greater than print height p120. As shown, rotation of feet 140 also causes printer 100 to step along step axis a150.

In the bottom frame of FIG. 3B, further rotation of feet 140 about foot axis a140 returns wheels 130 to surface 10.

FIG. 4 shows printer 100 having returned to the roll state and again rolling along roll axis a120, e.g., to print the next line of print. In the example shown, the printer prints this next line in the reverse direction to the previous print line.

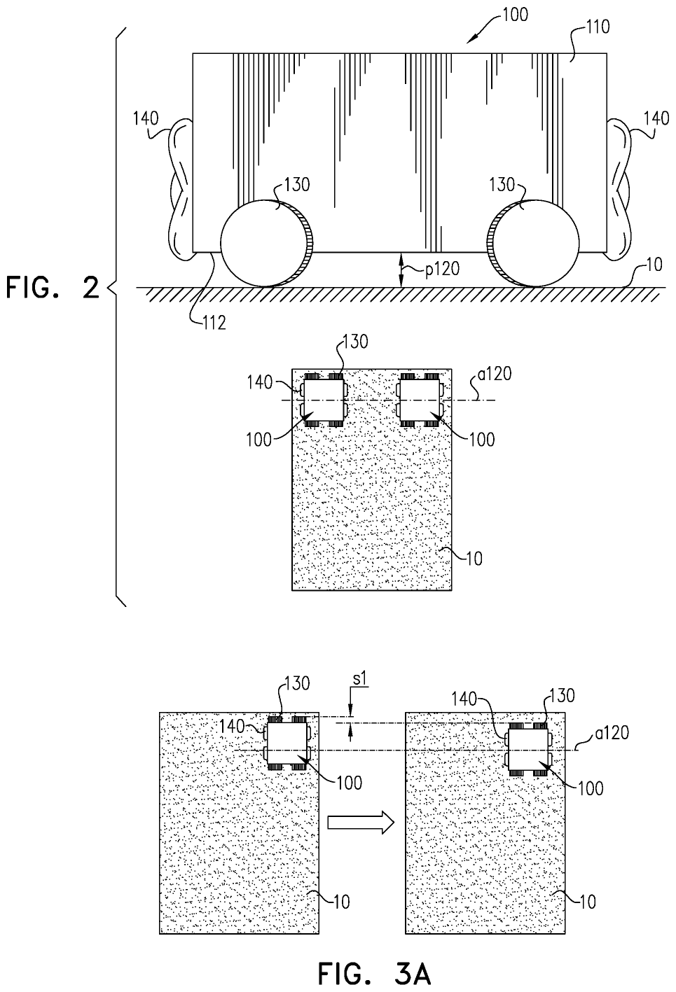

Reference is made to FIGS. 5-10, which are schematic illustrations showing a robotic printer 100a, in accordance with some applications of the invention. Printer 100a can be considered to be a variant of printer 100, and can be similar, at least in its general purpose, i.e., printing rows of material on surface 10, to printer 100 disclosed hereinabove, mutatis mutandis. Certain components of printer 100a correspond to, and are similar in their general purposes, to components of printer 100. These components of printer 100a make use of the same reference numerals as their respective corresponding components of printer 100, with addition of ‘a’.

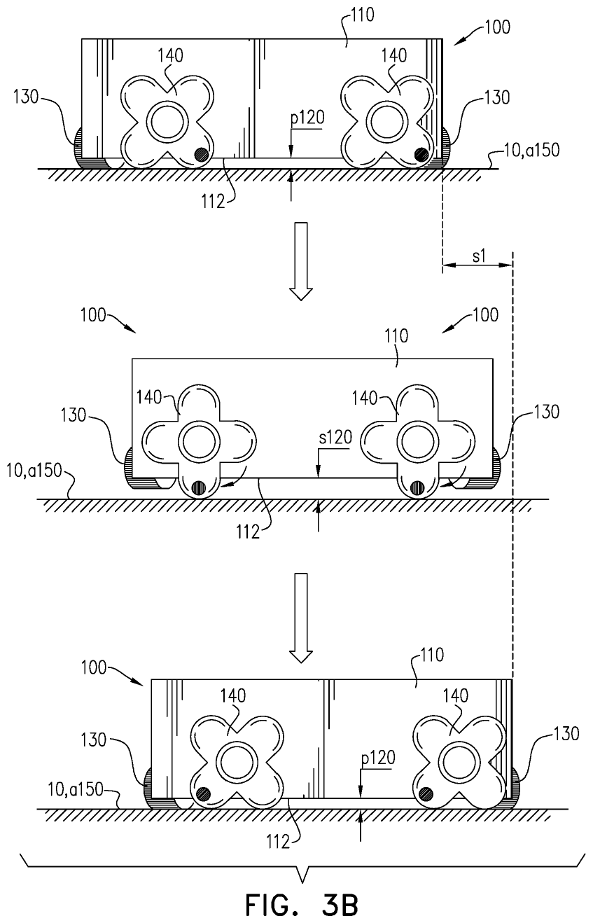

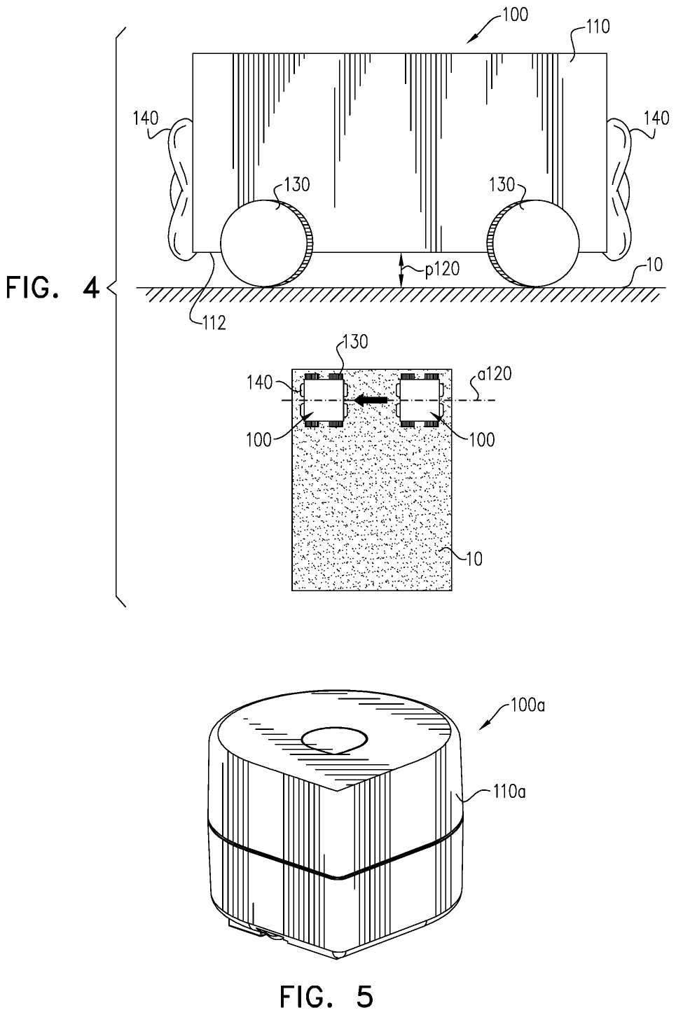

As shown in FIGS. 5-6, printer 100a comprises a housing 110a that houses a print head 120a, and wheels 130a at least partially protrude from base face 112a while printer 100a is in the roll state. For some implementations, and as shown in FIG. 7, wheels 130a are operated by rotating wheel axle 132a on which the wheels are mounted.

For some implementations, and as shown, printer 100a comprises an adjustment wheel 134a that is used, as needed, to adjust the direction in which wheels 130a roll, e.g., in case that printer 100a deviates from the roll axis.

For some implementations, and as shown, printer 100a comprises a tracking wheel 180a that is configured to track a distance travelled by the printer along roll axis a120a. For some such implementations, tracking wheel 180a is configured to track the distance independently of wheel 130a, e.g., by the tracking wheel maintaining contact with surface 10. For example, tracking wheel 180a may be coupled to an encoder 136a, while remaining rotationally decoupled/rotationally independent from wheels 130a or to wheel axle 132a.

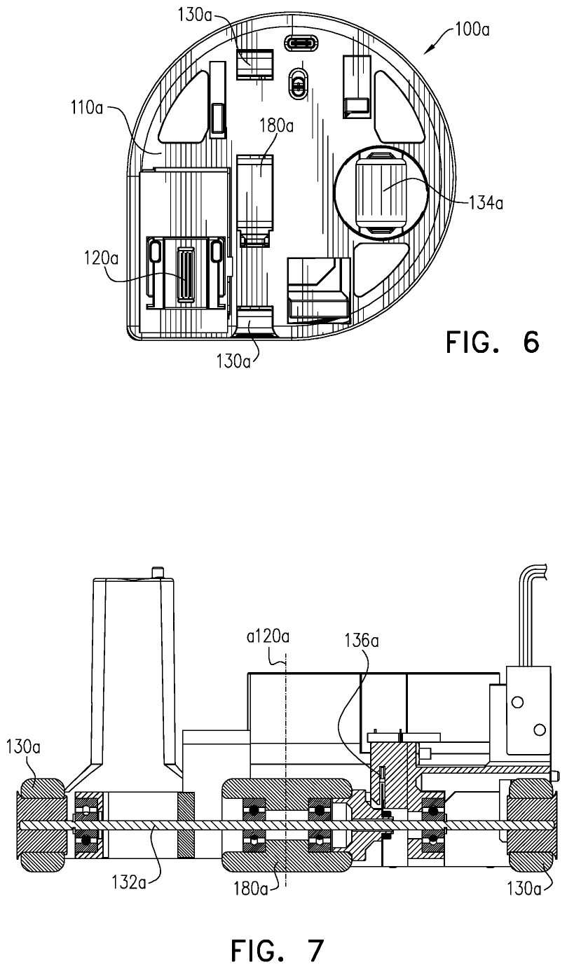

As shown in FIG. 8, printer 100a comprises a foot assembly 138a that is operated to cause printer 100a to take a step along step axis a150a. For some implementations, foot assembly 138a comprises a revolving foot 140a, revolution of which causes printer 100a to take a step along step axis a150a.

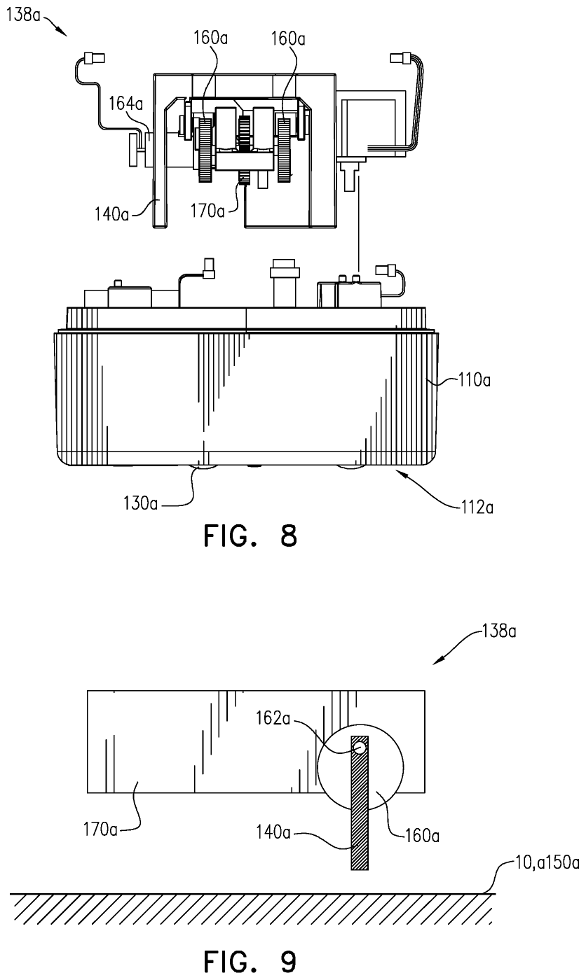

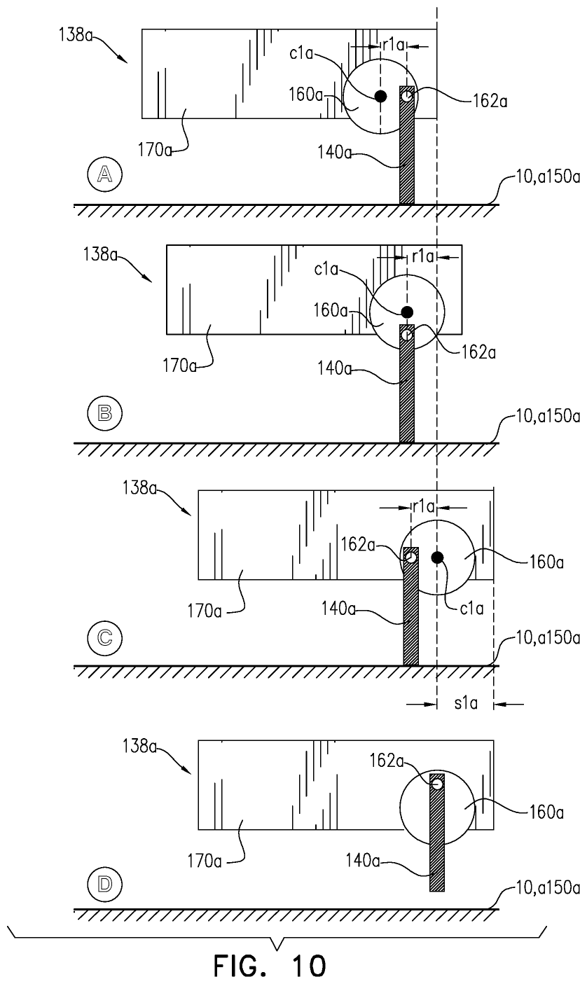

For some such implementations, and as shown in FIGS. 9 and 10, which are simplified schematic representations of foot assembly 138a causing printer 100a to take a step along step axis a150a. Although foot assembly 138a is typically at least partially housed within housing 110a (e.g., foot 140a may be disposed entirely housed by the housing during when printer 100a is in the roll state), for purposes of clarity the housing is not shown.

Typically for such implementations, foot 140a is coupled to a mount 170a (and thereby, to housing 110a and print head 120a) via a crank 160a. As described hereinbelow, revolving crank 160a (e.g., using a motor 164a, as shown in FIG. 8) causes foot 140a to revolve with respect to mount 170a, thereby propelling printer 100a along step axis 150a.

FIG. 8-9 show foot assembly 138a when printer 100a is in the roll state, during which foot 140a does not contact surface 10. While printer 100a is in in the roll state, wheels 130a and/or base face 112a contact surface 10, allowing printer 100a to roll along its roll axis a120a (FIG. 7).

Frame (a) of FIG. 10 shows foot assembly 138a after crank 160a and foot 140a have revolved clockwise in relation to mount 170a such that foot 140a contacts surface 10.

Frame (b) of FIG. 10 shows further revolution of crank 160a and foot 140a, while foot 140a remains at a constant position on surface 10, such that mount 170a, and therefore housing 110, is propelled along step axis a150a. At this stage, printer 100a is no longer in the roll state, such that housing 110 and wheels 130a are lifted away from surface 10.

Frame (c) of FIG. 10 shows further revolution of crank 160a and foot 140a, such that mount 170a, and therefore housing 110, is: (i) advanced along step axis a150a, and (ii) brought back towards surface 10. As shown by the dotted line along the first three frames of FIG. 10, mount 170a, and therefore housing 110, advances by a step length sla along step axis, e.g., while foot 140a remains at a constant position on surface 10. In this way, operation of foot 140a causes printer 100a to take a step along step axis a150a.

For some implementations, step length sla is determined by the manner in which mount 170a is coupled to foot 140a. For some such implementations, and as shown, mount 170a is coupled to crank 160a at a center point cla of the crank, and foot 140a is coupled to an off-center portion of crank 160a (e.g., by a pin 162a), at an effective crank radius rla from the center point. Note that crank radius rla is an effective crank radius because it is not necessarily the geometric radius of crank 160a.

Typically for such implementations, step length sla is determined by crank radius r1a. For example, and as shown, foot 140a revolving 90 degrees around center point cla advances mount 170 by crank radius r1a (frame (b) of FIG. 10), and revolving the foot 140a another 90 degrees around the center point advances the mount a step length s1a that is twice the crank radius.

For some such implementations, crank radius rla is adjustable. For example, the portion of crank 160a to which foot 140a is coupled may be changeable (e.g., by sliding pin 162a with respect to the crank). Alternatively or in addition, radius rla may be adjusted by altering coupling mount 170a to an alternate portion of crank 160a, e.g., not at center-point cla of the crank. Adjustment of crank radius r1a typically adjusts step length s1a, as described hereinabove.

Frame (d) of FIG. 10 shows still further revolution of crank 160a and foot 140a, such that printer 100a returns to the roll state shown in FIG. 9. Printer 100a has now completed the step, and the printer is positioned to print the next row of print along roll axis a120a.

The present invention is not limited to the examples that have been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. An apparatus, the apparatus comprising a robot that comprises:
an effector head;
a motorized wheel, coupled to the effector head, and configured to roll the effector head along a roll axis of a surface; and
a foot, the foot coupled to the effector head, and operable to walk the effector head along a step axis by, in order:
engaging the surface,
lifting the wheel from the surface,
while the wheel remains lifted from the surface, advancing the effector head along the step axis with respect to the surface, the step axis being orthogonal to the roll axis,
returning the wheel to the surface, and
disengaging from the surface.

2. The apparatus according to claim 1, wherein the foot is a first foot of a plurality of motorized feet, each of the feet being coupled to the effector head.

3. The apparatus according to claim 1, wherein the robot is configured to roll the effector head along the roll axis while the effector head is held at an effector height from the surface.

4. The apparatus according to claim 3, wherein the robot is configured such that operation of the foot elevates the effector head to a step-height from the surface, the step-height being greater than the effector height.

5. The apparatus according to claim 1, wherein the foot is operable to walk the effector head along the step axis by revolving the foot with respect to the effector head.

6. The apparatus according to claim 5, further comprising a crank, the crank:
coupling the foot to the effector head, and
configured to operate the foot by revolving the foot with respect to the effector head.

7. The apparatus according to claim 1, further comprising a housing that houses the effector head, wherein:
the housing has a base face,
the wheel is configured to roll the effector head along the roll axis while the base face faces the surface, and
the foot is operable to walk the effector head along the step axis by:
protruding from the base face,
while continuing to protrude from the base face, propelling the housing along the step axis, and
subsequently, retracting into the housing.

8. The apparatus according to claim 7, wherein the wheel is configured to roll the effector head along the roll axis while the foot does not protrude from the base face.

9. The apparatus according to claim 1, wherein the wheel is a first wheel of a set of motorized wheels, each wheel of the set being coupled to the effector head.

10. The apparatus according to claim 9, wherein the set of wheels is a set of four wheels.

11. The apparatus according to claim 9, wherein each wheel of the set is positioned laterally from the effector head.

12. The apparatus according to claim 1, wherein the wheel is a drive wheel, and wherein the robot further comprises a tracking wheel, configured to track a distance travelled by the robot along the roll axis.

13. The apparatus according to claim 12, wherein the tracking wheel is configured to track the distance independently of the drive wheel, via contact between the tracking wheel and the surface.

14. An apparatus for printing on a surface, the apparatus comprising a printer that comprises:
a print head, configured to print on the surface;
a housing, housing the print head;
a motorized wheel, coupled to the housing; and
a motorized foot, coupled to the housing,
wherein the printer is configured to rest on the surface such that:
in a roll state of the printer:
the wheel is in contact with the surface, such that turning of the wheel rolls the printer along the surface on a roll axis,
the print head is held at a constant print height from the surface, and
the foot is held away from the surface; and
operation of the foot causes the printer to take a step along the surface on a step axis that is orthogonal to the roll axis, the step transiently removing the printer from the roll state by lifting the wheel away from the surface.

15.-25. (canceled)

26. The apparatus according to claim 14, wherein:
the housing has a base face,
in the roll state, the base face faces the surface, and
operation of the foot causes the foot to, during the step:
protrude from the base face,
while continuing to protrude from the base face, propel the housing along the step axis, and
subsequently, retract into the housing.

27. The apparatus according to claim 26, wherein, while the printer is in the roll state, the foot does not protrude from the base face.

28.-31. (canceled)

32. The apparatus according to claim 14, wherein the wheel is a drive wheel, and wherein the printer further comprises a tracking wheel, configured to track a distance travelled by the printer along the roll axis.

33. The apparatus according to claim 32, wherein the tracking wheel is configured to track the distance independently of the drive wheel, via contact between the tracking wheel and the surface.

34. An apparatus for printing on a surface, the apparatus comprising a printer that comprises:
a print head, configured to print on the surface;
a motorized wheel, coupled to the print head, and configured to roll the print head along a roll axis of the surface while the print head is held at a print height from the surface; and
a foot, the foot coupled to the print head, and operable to walk the print head along a step axis by, in order:
engaging the surface,
lifting the wheel from the surface,
while the wheel remains lifted from the surface, advancing the print head along the step axis with respect to the surface, the step axis being orthogonal to the roll axis,
returning the wheel to the surface, and
disengaging from the surface.

35-40. (canceled)

41. The apparatus according to claim 34, wherein the printer is configured such that operation of the foot elevates the print head to a step-height from the surface, the step-height being greater than the print height.

42. The apparatus according to claim 34, wherein the foot is operable to walk the print head along the step axis by revolving the foot with respect to the print head.

43. The apparatus according to claim 42, further comprising a crank, the crank:
coupling the foot to the print head, and
configured to operate the foot by revolving the foot with respect to the print head.

44-48. (canceled)

49. The apparatus according to claim 34, wherein the wheel is a drive wheel, and wherein the printer further comprises a tracking wheel, configured to track a distance travelled by the printer along the roll axis.

50. The apparatus according to claim 49, wherein the tracking wheel is configured to track the distance independently of the drive wheel, via contact between the tracking wheel and the surface.
